(19) United States
(12) Patent Application Publication
(10) Pub. No.: US 2026/0243148 A1
(43) Pub. Date: Aug. 20, 2026

(54) REMOTELY OPERATED WIRELESS VALVE ACTUATOR ASSEMBLY

(71) Applicant: M & M Oil Tools, LLC, Breaux Bridge, LA (US)

(72) Inventors: Andy Paul Todd, Lafayette, LA (US); Paul John George Brebner, Esbjerg (DK)

(73) Assignee: M & M Oil Tools, LLC, Breaux Bridge, LA (US)

(21) Appl. No.: 19/543,353

(22) Filed: Feb. 18, 2026

Related U.S. Application Data
(60) Provisional application No. 63/759,863, filed on Feb. 18, 2025.

(51) Int. Cl. E21B 34/06; F16K 31/46

(52) U.S. Cl. CPC E21B 34/066; F16K 31/46

(57) ABSTRACT

A remotely operated wireless valve actuator assembly for use with a valve sub is disclosed. The valve sub includes a sub housing, a ball valve disposed within the sub housing, and a valve stem configured to rotate the ball valve between an open position and a closed position. The assembly includes an actuator unit mounted to the valve sub and including an actuator stem configured to engage and rotate the valve stem. The assembly further includes a power unit mounted to the valve sub for receiving a remote user input, processing the user input, and operating the actuator unit accordingly via supply lines that connect the power unit to the actuator unit. The power unit operates the actuator unit to rotate the actuator stem, thereby moving the ball valve between an open and closed position within the valve sub.

### CROSS-REFERENCE TO RELATED APPLICATIONS

This application claims priority to U.S. Application No. 63/759,863, titled “Remotely Operated Wireless Valve Actuator Assembly,” filed February 18, 2025, which is hereby incorporated by reference in its entirety.

### FIELD OF INVENTION

The present disclosure relates to valve actuator assemblies for drilling rig safety valves, and more particularly to a remotely operated wireless valve actuator assembly having an actuator unit and a power unit both mounted to a valve sub to enable remote actuation without manual connection of supply lines.

### BACKGROUND

In the oil and gas industry, valve subs are commonly employed within drill strings to control fluid flow during drilling, workover, and completion operations. A valve sub typically includes a tubular housing containing a ball valve cartridge that can be rotated between open and closed positions via a valve stem accessible from the exterior of the housing. These valve subs serve as safety valves, such as drill string safety valves (DSSVs), which can be quickly installed into a drill string and closed to seal the bore when well control situations arise.

Traditionally, rig personnel manually operate these safety valves using wrenches that engage the valve stem. However, manual operation presents challenges, particularly when the valve is under high pressure or located in difficult-to-reach positions, such as valve subs positioned thirty feet or more above the rig floor. The application of torque to a valve stem under high pressure conditions can expose workers to hazards including high-pressure fluid jets from seal failures or projectiles from mechanical failures of valve components.

Powered actuator assemblies have been developed to address some of these concerns by providing mechanical means to actuate valve stems remotely. Existing actuator assemblies, such as the actuator assemblies disclosed in U.S. Patent Nos. 11,674,613 and 12,000,501, which are incorporated by reference in their entireties herein, typically include an actuator unit mounted to the valve sub and a separate portable hydraulic unit that remains disconnected from the valve sub during normal operations. When actuation is desired, an operator manually connects hydraulic hoses from the portable hydraulic unit to the actuator unit, moves to a safe distance, and then actuates the valve. After actuation, the hoses are disconnected before the valve sub rotates during drilling operations, as connected hoses would become tangled around the rotating valve sub.

This arrangement of repeatedly connecting and disconnecting hoses introduces operational inefficiencies and potential safety concerns. Each connection event requires personnel to approach the valve sub, which may be under pressure or in an elevated position. The manual connection process can be time-consuming and physically demanding, particularly in adverse weather conditions or emergency situations where rapid valve actuation is desired. Furthermore, the repeated connection and disconnection of hydraulic fittings can lead to wear on the connections and potential for leaks or failures over time.

Accordingly, there exists a need for valve actuator assemblies that can provide remote actuation capabilities while reducing or eliminating the need for manual connection of supply lines each time valve actuation is desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure addresses the problem of manual connection and disconnection of supply lines between an actuator unit and a power unit each time valve actuation is desired. By mounting both the actuator unit and the power unit to the valve sub, the supply lines can remain connected without tangling when the valve sub rotates during drilling operations, thereby eliminating the need for personnel to approach the valve sub to manually connect hoses or cables prior to each actuation event.

In a particular embodiment exemplifying the principle of the invention, the remotely operated wireless valve actuator assembly may include an actuator unit, a power unit, a supply line, a first mounting plate, and a second mounting plate. The actuator unit may include an actuator stem and may be configured to rotate the actuator stem. The supply line may connect the actuator unit to the power unit. The power unit may be configured to send a control signal through the supply line to cause the actuator unit to rotate the actuator stem. The first mounting plate may be configured to mount the actuator unit to a valve sub, while the second mounting plate may be configured to mount the power unit to the valve sub. The actuator unit may be a rotary or a linear actuator unit. The linear actuator unit may include a hydraulic cylinder and a crank arm. The crank arm may be configured to convert linear motion of the hydraulic cylinder into rotational motion of the actuator stem. The power unit may be a hydraulic, pneumatic, or electric power unit. The power unit may comprise a power source, a controller configured to receive and process a remote user input, and a pump configured to generate hydraulic or pneumatic pressure and to deliver the hydraulic or pneumatic pressure to the actuator unit via the supply line. The power unit may comprise a control panel configured to deliver electric signals and power to the actuator unit via the supply line. The supply line may be a hose or a cable. The first mounting plate may comprise a first surface for supporting the actuator unit and a second surface configured to engage the valve sub. The second mounting plate may comprise a first surface for supporting the power unit and a second surface for engaging the valve sub.

In another embodiment exemplifying the principles of the invention, a valve sub assembly may comprise a valve sub and a remotely operated wireless valve actuator assembly. The valve sub may comprise a valve sub comprising a sub housing, a ball valve disposed within the sub housing, a valve stem configured to rotate the ball valve between an open position and a closed position, and a stem aperture extending through the sub housing to reach the valve stem. The remotely operated wireless valve actuator assembly may comprise an actuator unit mounted on the valve sub, a power unit mounted on the valve sub, and a supply line connecting the power unit to the actuator unit. The actuator unit may comprise an actuator stem extending through the stem aperture and engaging the valve stem. The power unit may be configured to operate the actuator unit to rotate the actuator stem, wherein rotation of the actuator stem causes rotation of the valve stem, wherein rotation of the valve stem causes the ball valve to move between an open position and a closed position within the valve sub. The supply lines may be configured to remain connected between the actuator unit and the power unit when the valve sub rotates during drilling operations.

In yet another embodiment exemplifying the principles of the invention, a method of actuating a remotely operated wireless valve actuator assembly is disclosed. The method may include the step of mounting a power unit to a valve sub. The valve sub may comprise a sub housing, a ball valve disposed within the sub housing, a valve stem configured to rotate the ball valve between an open position and a closed position, and a stem aperture extending through the sub housing to reach the valve stem. The method may further include the step of mounting an actuator unit to the valve sub. The actuator unit may comprise an actuator stem, wherein upon mounting the actuator stem extends through the stem aperture and engages the valve stem. The method may further include the steps of connecting the actuator unit to the power unit via a supply line, receiving a remote user input at the power unit, and sending a control signal from the power unit to the actuator unit via the supply line to cause the actuator unit to rotate the actuator stem, thereby rotating the valve stem to move the ball valve between the open position and the closed position. In some embodiments, sending the control signal may comprise supplying fluid or gas through the supply line. In some embodiments, sending the control signal may comprise supplying electrical power through the supply line.

The above summary is not intended to describe each illustrated embodiment or every possible implementation. These and other features, aspects, and advantages of the present invention will become better understood with regard to the following description, appended claims, and accompanying drawings.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 illustrates a front perspective view of a remotely operated wireless valve actuator assembly exemplifying principles of the present invention mounted to a valve sub;

FIG. 2 illustrates a back perspective view of the remotely operated wireless valve actuator assembly of FIG. 1;

FIG. 3 illustrates a partial sectional view of the remotely operated wireless valve actuator assembly of FIG. 1, in which a portion of the wireless valve actuator assembly and a portion of a housing of the valve sub are removed to reveal internal components;

FIG. 4 illustrates a front perspective view of an alternative embodiment of the remotely operated wireless valve actuator assembly exemplifying principles of the present invention mounted to a valve sub, wherein an actuator unit of the remotely operated wireless valve actuator assembly is shown in an extended position;

FIG. 5 illustrates a back perspective view of the remotely operated wireless valve actuator assembly of FIG. 4;

FIG. 6 illustrates a front perspective view of the remotely operated wireless valve actuator assembly of FIG. 4, wherein the actuator unit is shown in a retracted position;

FIG. 7 illustrates a partial sectional view of the remotely operated wireless valve actuator assembly of FIG. 4, in which a portion of the wireless valve actuator assembly and a portion of a housing of the valve sub are removed to reveal internal components.

### DETAILED DESCRIPTION OF THE PREFERRED EMBODIMENTS

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

The present disclosure relates to a remotely operated wireless valve actuator assembly for use in connection with a safety valve on a drilling rig. The remotely operated wireless valve actuator assembly may be configured to actuate a ball valve within a valve sub between open and closed positions. The valve sub may include a sub housing, a ball valve positioned within the sub housing, a valve stem configured to rotate the ball valve, and a stem aperture extending through the sub housing to provide access to the valve stem.

In some embodiments, the remotely operated wireless valve actuator assembly may include an actuator unit and a power unit, both of which may be mounted to the valve sub. The actuator unit may include an actuator stem configured to engage the valve stem of the valve sub. When the power unit is activated, the power unit may cause the actuator to rotate the actuator stem, which in turn may rotate the valve stem and thereby move the ball valve between open and closed positions within the valve sub.

By mounting both the actuator unit and the power unit to the valve sub, supply lines connecting the actuator unit to the power unit may remain connected during operation. In some embodiments, the valve sub may rotate during drilling or workover operations. Because the actuator unit and the power unit are both mounted to the valve sub, the supply lines may rotate together with the valve sub, thereby preventing tangling of the supply lines. This configuration may eliminate the need for manual connection of the supply lines to the actuator unit each time actuation of the ball valve is desired.

The power unit may be configured for remote activation. In some embodiments, the power unit may include a power source such as a battery or a solar panel, a controller for receiving user input, and a pump configured to process received signals and operate the actuator unit accordingly. In other embodiments, the power unit may include a control panel that integrates the functionalities of the power source, the controller, and the pump into a singular component. The power unit may receive wireless signals from a remote location, allowing a user to actuate the ball valve cartridge without being positioned adjacent to the valve sub. This remote actuation capability may provide safety benefits, particularly when the valve sub is positioned at elevated locations on a drilling rig.

The actuator unit may be a rotary actuator unit or a linear actuator unit. The power unit may be hydraulic, pneumatic, or electric. In some embodiments, a hydraulic or pneumatic actuator power unit may be used with a rotary actuator unit, with hoses serving as the supply lines. In other embodiments, an electric actuator power unit may be used with a linear actuator unit, with cables serving as the supply lines. The remotely operated wireless valve actuator assembly may be used in a variety of workover or completion operations.

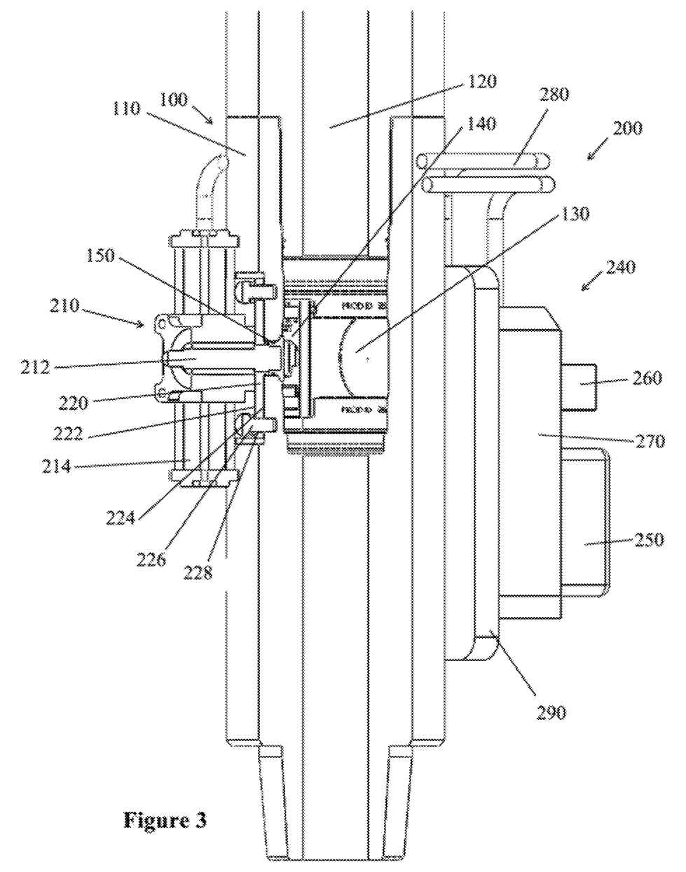

With reference to FIG. 3, a valve sub 100 may be configured to function as a safety valve in drilling operations. The valve sub 100 may include a sub housing 110 that provides a structural framework for the valve sub 100. The sub housing 110 may be a tubular structure configured to be positioned within a drill string or other drilling equipment. The sub housing 110 may include a central bore 120 extending therethrough.

As shown in FIG. 3, a ball valve 130 may be positioned within the sub housing 110. The ball valve 130 may be configured to control fluid flow through the central bore 120 of the valve sub 100. In some embodiments, the ball valve 130 may be the ball valve cartridge disclosed in U.S. Patent No. 12,546,408, which is incorporated by reference herein in its entirety. The ball valve 130 may be a spherical element with a bore extending therethrough. When the bore of the ball valve 130 is aligned with the flow path through the central bore 120 of the sub housing 110, the ball valve 130 and the valve sub 100 may be in an open position, allowing fluid to flow through the central bore 120 of the valve sub 100. When the ball valve 130 is rotated such that the bore is not aligned with the flow path, the ball valve 130 and the valve sub 100 may be in a closed position, preventing fluid flow through the central bore 120 of the valve sub 100.

With continued reference to FIG. 3, one or more valve stems 140 may be configured to rotate the ball valve 130 and cause the valve sub 100 to move between the open and closed positions. The valve stems 140 may be mechanically coupled to the ball valve 130 such that rotation of one or more of the valve stems 140 causes corresponding rotation of the ball valve 130. In some embodiments, the valve stems 140 may extend from the ball valve 130 toward an exterior surface of the sub housing 110.

As illustrated in FIG. 3, one or more stem apertures 150 may extend through the sub housing 110 to reach the valve stems 140. The stem apertures 150 may provide access to the valve stems 140 from an exterior of the valve sub 100. In some embodiments, the valve stems 140 may extend through the stem aperture 150. In other embodiments, the stem apertures 150 may be configured to receive one or more actuator stems that engage the one or more valve stems 140. The stem apertures 150 may allow external actuation of the valve stems 140 without requiring disassembly of the valve sub 100.

The valve sub 100 may function as a safety valve in drilling operations by providing a mechanism for controlling fluid flow through the drill string. In some embodiments, the valve sub 100 may be actuated to close the ball valve 130 in response to a well control event or other emergency condition. The valve sub 100 may also be used during workover or completion operations to isolate sections of the wellbore.

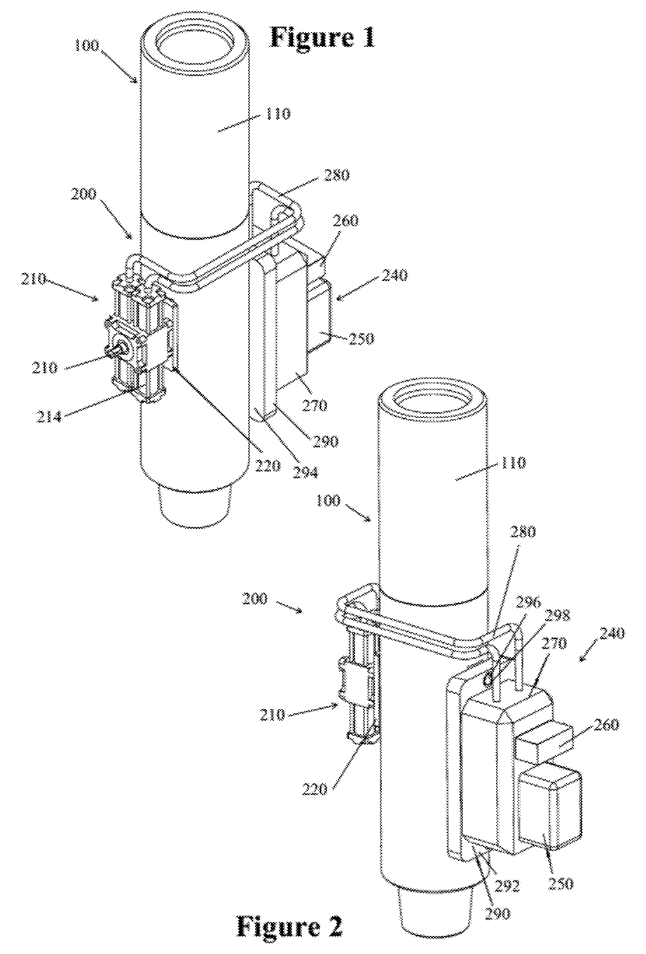

An embodiment of a remotely operated wireless valve actuator assembly 200 embodying the principles of the present invention is depicted in FIGS. 1-3. The remotely operated wireless valve actuator assembly 200 may be mounted to the valve sub 100. The remotely operated wireless valve actuator assembly 200 may include an actuator unit 210 and a power unit 240. The actuator unit 210 and the power unit 240 may both be attached to the valve sub 100, allowing the components to rotate together with the valve sub 100 during drilling operations.

The actuator unit 210 shown in FIGS. 1-3 may be a rotary actuator unit configured to provide rotational motion for actuating the ball valve 130 within the valve sub 100. In some embodiments, the actuator unit 210 may include an actuator stem 212 that engages the valve stem 140 of the valve sub 100. When the actuator unit 210 is operated, the actuator stem 212 may rotate, which in turn may rotate the valve stem 140 and thereby rotate the ball valve 130 and move the valve sub 100 between the open and closed positions. The actuator unit 210 may be formed by piston and cylinder assembles 214. The actuator stem 212 may extend through the actuator unit 210, and torque may be applied to the actuator stem 212 by the pistons or rams of the piston and cylinder assemblies 214.

As illustrated in FIGS. 1-3, the actuator unit 210 may be attached to the valve sub 100 via a first mounting plate 220. The first mounting plate 220 may be configured to secure the actuator unit 210 to an exterior surface of the sub housing 110. The first mounting plate 220 may be configured to position the actuator unit 210 such that the actuator stem 212 aligns with the stem aperture 150 of the valve sub 100. As shown in FIG. 3, the first mounting plate 220 may include an outer surface 222 and an inner surface 224. The outer surface 222 of the first mounting plate 220 may be configured to be connected to the actuator unit 210. The first mounting plate 220 and the actuator unit 210 may be provided as a single, integrally formed structure or may be coupled—directly or indirectly—by any suitable permanent or releasable joining method, including mechanical fasteners, threaded engagement, interference fits, welding, brazing, soldering, adhesive bonding, snap‑fits, magnetic couplings, or functionally equivalent techniques. The inner surface 224 of the first mounting plate 220 may be configured to be connected to the sub housing 110 of the valve sub 100. The inner surface 224 may include a curved portion having substantially the same curvature as the curvature of an outer surface of the sub housing 110. In some embodiments, “substantially the same” means the radius of curvature of the curved portion of the inner surface 224 is within 20% (more preferably within 15%, 10%, or 5%) of the radius of curvature of the sub housing 110. The first mounting plate 220 and the sub housing 110 may be provided as a single, integrally formed structure or may be coupled—directly or indirectly—by any suitable permanent or releasable joining method, including mechanical fasteners, threaded engagement, interference fits, welding, brazing, soldering, adhesive bonding, snap‑fits, magnetic couplings, or functionally equivalent techniques. The inner surface 224 may be coupled to the sub housing 110 via any suitable means such as mechanical fasteners or clamps. In some embodiments, the inner surface 224 of the first mounting plate 220 may be coupled to the sub housing 110 via screws 226 extending through apertures 228 in the first mounting plate 220 and threaded into the sub housing 110. In alternate embodiments, the actuator unit 210 may be attached to the valve sub 100 directly, via any suitable means such as mechanical fasteners or clamps.

With reference to FIGS. 1-3, the actuator unit 210 may be operated by the power unit 240. The power unit 240 may be a hydraulic or pneumatic power unit. The power unit 240 may include a power source 250 to provide electrical power to operate components of the power unit 240, a controller 260 for receiving and processing remote user inputs, and a pump 270 for operating the actuator unit 210. In some embodiments, the power unit 240 may include a battery as the power source 250. In alternate embodiments, the power source 250 may be a solar panel.

Still referring to FIGS. 1-3, the controller 260 may be configured to receive and process remote user inputs and transmit commands to the other components of the power unit 240. The controller 260 may be configured to receive wireless signals from a user while the user is in a remote location, allowing the user to actuate the ball valve 130 without being positioned adjacent to the valve sub 100. The controller 260 may process the received signals and transmit corresponding commands to other components of the actuator power unit 210, such as to the pump 270.

The pump 270 shown in FIGS. 1-3 may be configured to receive and process commands from the controller 260 and operate the actuator unit 210 accordingly. In some embodiments, the pump 270 may be in the form of hydraulic or pneumatic pump and may include an integrated reservoir. The reservoir may be configured to store hydraulic fluid or compressed gas, and the pump 270 may be configured to pressurize the hydraulic fluid or gas. The pump 270 may generate a control signal, such as hydraulic or pneumatic pressure, to drive the actuator unit 210 in response to commands received from the controller 260.

As further shown in FIGS. 1-3, supply lines 280 may connect the power unit 240 to the actuator unit 210 and allow the power unit 240 to send the control signal to the actuator unit 210. More specifically, the supply lines 280 may connect the pump 270 to the actuator unit 210. In some embodiments, the supply lines 280 may be hoses configured to convey hydraulic fluid or pneumatic pressure from the pump 270 of the power unit 240 to the actuator unit 210. In certain embodiments, the supply lines 280 may include a supply hose for delivering pressurized fluid or gas to the actuator unit 210 and a return hose for returning fluid or gas to the pump 270 of the power unit 240.

Referring to FIGS. 1-3, the power unit 240 may be attached to the valve sub 100 via a second mounting plate 290. The second mounting plate 290 may include an outer surface 292 (shown in FIG. 2) and an inner surface 294 (shown in FIG. 1). The outer surface 292 of the second mounting plate 290 may be configured to be connected to the power unit 240. The second mounting plate 290 and the power unit 240 may be provided as a single, integrally formed structure or may be coupled—directly or indirectly—by any suitable permanent or releasable joining method, including mechanical fasteners, threaded engagement, interference fits, welding, brazing, soldering, adhesive bonding, snap‑fits, magnetic couplings, or functionally equivalent techniques. The inner surface 294 of the second mounting plate 290 may be configured to be connected to the sub housing 110 of the valve sub 100. The inner surface 294 may include a curved portion having substantially the same curvature as the curvature of an outer surface of the sub housing 110. In some embodiments, “substantially the same” means the radius of curvature of the curved portion of the inner surface 294 is within 20% (more preferably within 15%, 10%, or 5%) of the radius of curvature of the sub housing 110. The second mounting plate 290 and the sub housing 110 may be provided as a single, integrally formed structure or may be coupled—directly or indirectly—by any suitable permanent or releasable joining method, including mechanical fasteners, threaded engagement, interference fits, welding, brazing, soldering, adhesive bonding, snap‑fits, magnetic couplings, or functionally equivalent techniques. The inner surface 294 may be coupled to the sub housing 110 via any suitable means such as mechanical fasteners or clamps. In some embodiments, such as the embodiment depicted in FIG. 2, the inner surface 294 of the actuator unit mounting plate may be coupled to the sub housing 110 via screws 296 extending through apertures 298 in the second mounting plate 290 and threaded into the sub housing 110. In alternate embodiments, the power unit 240 may be attached to the valve sub 100 directly, via any suitable means such as mechanical fasteners or clamps.

Because both the actuator unit 210 and the power unit 240 are mounted to the valve sub 100 via mounting plates 220 and 290, the supply lines 280 may remain connected during operation. When the valve sub 100 rotates during drilling or workover operations, the actuator unit 210, the power unit 240, and the supply lines 280 may rotate together with the valve sub 100, thereby preventing tangling of the supply lines 280.

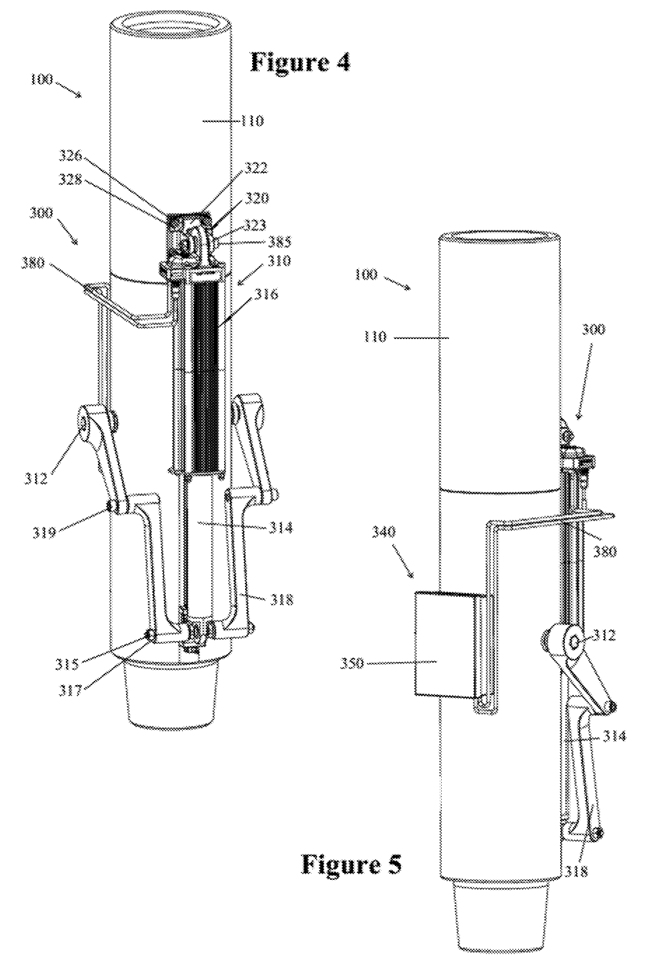

An alternative embodiment of the remotely operated wireless valve actuator assembly 300 of the present invention is depicted in FIGS. 4-7. In this embodiment, the actuator unit 310 may be a linear actuator unit, and the power unit 340 may be an electric power unit.

As shown in FIG. 4, the actuator unit 310 may include a hydraulic cylinder including a piston rod 314 at least partially disposed within a cylinder tube 316 that together form a main body of the hydraulic cylinder. The piston rod 314 may be driven by a motor that causes the piston rod 314 to move in a linear direction relative to the cylinder tube 316 between an extended position and a retracted position. In some embodiments, the motor is an electric motor. The motor may operatively interface with a translation mechanism that includes a lead screw, a drive nut, or any functionally equivalent rotary-to-linear conversion component. The lead screw and drive nut may be provided in any suitable form, geometry, or material and may be arranged in any configuration capable of converting motor-generated rotation into linear displacement of the piston rod 314 relative to the cylinder tube 316.

As illustrated in FIG. 4, one or more crank arms 318 may extend from the piston rod 314 of the actuator unit 310. The crank arms 318 may be configured to convert linear motion of the piston rod 314 between the extended position and the retracted position into rotational motion. In some embodiments, two crank arms 318 may be positioned on opposite sides of the piston rod 314 and may be secured to the piston rod 314 via a crank arm bolt 315 and nuts 317. The crank arm bolt 317 may pass through one end of each of the crank arms 318 and through an aperture in the piston rod 314. When the piston rod 314 moves up or down, the crank arms 318 may pivot to produce rotational movement. Each of the crank arms 318 may be formed of a single segment or more than one segment. In the embodiment shown in FIG. 4, each crank arm 318 is formed of two segments, with a first segment connected to the piston rod 314 and a pivot pin 319 securing the two segments together.

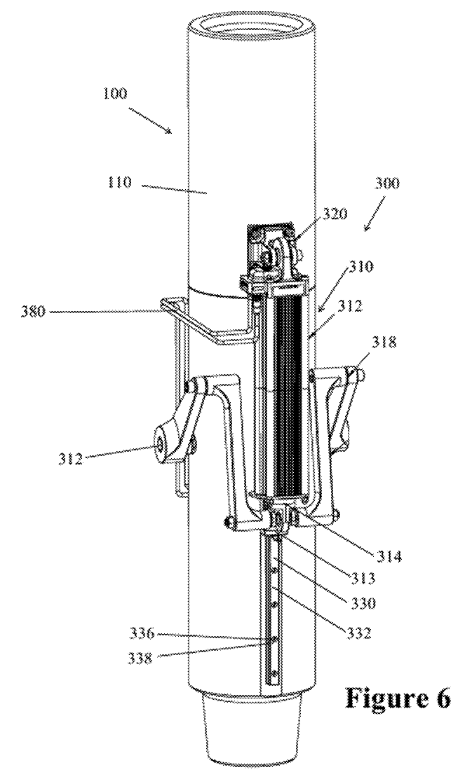

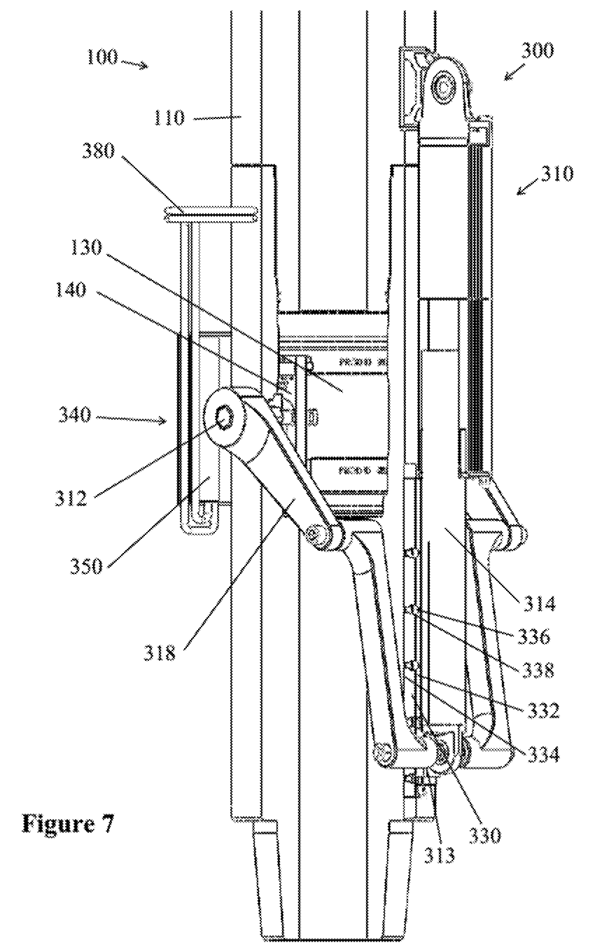

As shown in FIGS. 4-7, one or more actuator stems 312 may be engaged by the crank arms 318. In some embodiments, the actuator stems 312 are engaged by a second segment of each of the crank arms 318. Each of the actuator stems 312 may extend through the sub housing 110 to interface with one or more valve stems 140 (shown in FIG. 7). The actuator stems 312 may include an external surface having a generally polygonal geometry, such as a hexagonal profile, configured to mate with a corresponding hexagonally shaped aperture in each of the crank arms 318. The hexagonal surface and corresponding aperture may be dimensioned to engage one another in a manner that inhibits relative rotation while permitting axial insertion and withdrawal, and may be provided in any suitable tolerance, orientation, or variant of polygonal interlocking geometry. Thus, when the crank arms 318 pivot in response to linear motion of the piston rod 314, the crank arms 318 may cause the actuator stems 312 to rotate. The rotation of the actuator stems 312 may in turn rotate the valve stems 140, thereby rotating the ball valve 130 and moving the valve sub 100 between open and closed positions. Specifically, FIG. 6 illustrates the piston rod 314, the crank arms 318, and the actuator stem 312 in a configuration corresponding to a particular valve sub position, such as a closed position. When the piston rod 314 moves toward the extended position shown in FIG. 4, the crank arms 318 may rotate the actuator stems 312 to move the ball valve 130 to an open position. When the piston rod 314 moves toward the retracted position shown in FIG. 6, the crank arms 318 may rotate the actuator stems 312 to move the ball valve 130 to a closed position.

With reference to FIGS. 4 and 6, the first mounting plate 320 may be configured to secure the actuator unit 310 to the exterior surface of the sub housing 110. More specifically, the first mounting plate 320 may be configured to secure the cylinder tube 316 to the sub housing 110. The outer surface 322 of the first mounting plate 320 may be configured to be connected to the cylinder tube 316. In some embodiments, such as the embodiment depicted in FIG. 4, the outer surface 322 of the first mounting plate 320 may include a clevis joint 323 and a pin 385 extending through apertures in the clevis joint 323 and an aperture in the upper end of the cylinder tube 316. The inner surface of the first mounting plate 320 may be coupled to the sub housing 110 via screws 326 extending through apertures 328 in the first mounting plate 320 and threaded into the sub housing 110. In alternate embodiments, the actuator unit 310 may be attached to the valve sub 100 directly, via any suitable means such as mechanical fasteners or clamps.

Still referring to FIGS. 6 and 7, the piston rod 314 of the hydraulic cylinder of the linear actuator unit 310 may be slidingly attached to the housing via a track 330. The track 330 may be configured to guide movement of the piston rod 314 between the extended position and the retracted position. The track 330 may define an elongated guideway having any suitable profile—such as a rail, channel, slot, groove, dovetail, or equivalent. The track 330 may include an outer surface 332 and an inner surface 334. The outer surface 332 may be configured to be slidingly connected to the piston rod 314. Specifically, the piston rod 314 may include a sliding component 313 that may incorporate one or more follower elements (e.g., recirculating ball carriages, roller elements, bushings, sleeves, or low-friction pads) configured to operatively engage the guideway to maintain alignment and resist off-axis loads produced during movement of the piston rod 314. The inner surface 334 of the track 330 may be configured to be connected to the sub housing 110 of the valve sub 100. The inner surface 334 may include a curved portion having substantially the same curvature as the curvature of an outer surface of the sub housing 110. In some embodiments, “substantially the same” means the radius of curvature of the curved portion of the inner surface 334 is within 20% (more preferably within 15%, 10%, or 5%) of the radius of curvature of the sub housing 110. The track 330 and the sub housing 110 may be provided as a single, integrally formed structure or may be coupled—directly or indirectly—by any suitable permanent or releasable joining method, including mechanical fasteners, threaded engagement, interference fits, welding, brazing, soldering, adhesive bonding, snap‑fits, magnetic couplings, or functionally equivalent techniques. The inner surface 334 may be coupled to the sub housing 110 via any suitable means such as mechanical fasteners or clamps. In some embodiments, the inner surface 334 of the track 330 may be coupled to the sub housing 110 via screws 336 extending through apertures 338 in the track 330 and threaded into the sub housing 110.

As illustrated in FIGS. 5 and 7, the power unit 340 may include a control panel 350. The control panel 350 may be configured to receive wireless signals from a remote location, process the received signals, and operate the actuator unit 310 accordingly. The control panel 350 may include an integrated power supply that supplies power for operation of the control panel 350 and the actuator unit 310. In some embodiments, the control panel 350 provides electrical communication and power to the motor of the actuator unit 310.

With reference to FIGS. 4-7, supply lines 380 may connect the power unit 340 to the actuator unit 310 and allow the power unit 340 to send control signals to the actuator unit 310. More specifically, the supply lines 380 may connect the control panel 350 to the actuator unit 310. In some embodiments, the supply lines 380 may be cables configured to provide electrical communication and/or power between the control panel 350 and the actuator unit 310.

With reference to FIG. 5, the second mounting plate may be integrally formed with the control panel 350 or may be coupled—directly or indirectly—by any suitable permanent or releasable joining method including mechanical fasteners, threaded engagement, interference fits, welding, brazing, soldering, adhesive bonding, snap‑fits, magnetic couplings, or functionally equivalent techniques, and may be configured to secure the control panel 350 to the sub housing 110. In alternate embodiments, the power unit 340 may be attached to the valve sub 100 directly, via any suitable means such as mechanical fasteners or clamps.

During operation of the remotely operated wireless valve actuator assembly 200, 300, a user may initiate actuation of the ball valve 130 from a remote location. The user may transmit a wireless signal to the power unit 240, 340, which may receive the wireless signal and process the user input. In some embodiments, the user may be positioned at a safe distance from the valve sub 100, such as on a drilling floor when the valve sub 100 is positioned at an elevated location on a drilling rig.

Upon receiving the command from the user, the power unit 240, 340 may generate the appropriate output to operate the actuator unit 210, 310. In embodiments utilizing a hydraulic or pneumatic actuator power unit 240, the power unit 240 may pressurize hydraulic fluid or gas and deliver the pressurized fluid or gas through the supply lines 280 to the actuator unit 210. In embodiments utilizing an electric actuator power unit 340, the power unit 240 may transmit electrical signals through the supply lines 380 to operate a motor within the actuator unit 310.

The actuator unit 210, 310 may convert the received power into mechanical motion to rotate the actuator stem 212, 312. In embodiments utilizing a rotary actuator unit 210, the actuator unit 210 may directly rotate the actuator stem 212 in response to hydraulic or pneumatic pressure received through the supply lines 280 from the power unit 240. In embodiments utilizing a linear actuator unit 310, the piston rod 314 may move in a linear direction, and the crank arms 318 may convert the linear motion into rotational motion of the actuator stem 312.

The actuator stem 212, 312 may engage the valve stem 140 of the valve sub 100. When the actuator stem 212, 312 rotates, the valve stem 140 may rotate correspondingly. The rotation of the valve stem 140 may cause the ball valve 130 to rotate between open and closed positions. In some embodiments, rotation of the valve stem 140 in a first rotational direction may move the ball valve 130 to an open position, and rotation of the valve stem 140 in a second rotational direction opposite the first rotational direction may move the ball valve 130 to a closed position.

Because both the actuator unit 210, 310 and the power unit 240, 340 are mounted to the valve sub 100, the supply lines 280, 380 connecting the actuator unit 210, 310 to the power unit 240, 340 may remain connected during drilling operations. When the valve sub 100 rotates during drilling or workover operations, the actuator unit 210, 310, the power unit 240, 340, and the supply lines 280, 380 may rotate together with the valve sub 100. This co-rotation may prevent tangling of the supply lines 280, 380 that would otherwise occur if the power unit 240, 340 were not mounted to the valve sub 100. The configuration may eliminate the need for manual connection and disconnection of the supply lines 280, 380 each time actuation of the ball valve 130 is desired.

The remotely operated wireless valve actuator assembly 200, 300 may be used in a variety of workover or completion operations in drilling applications. In workover operations, the remotely operated wireless valve actuator assembly may be used to actuate the ball valve 130 to control fluid flow during well intervention activities. In completion operations, the remotely operated wireless valve actuator assembly 200, 300 may be used to actuate the ball valve 130 during installation of completion equipment or during testing of the well. The remote actuation capability may provide safety benefits in these applications by allowing personnel to remain at a safe distance from the valve sub 100 during actuation.

Many modifications and other embodiments of the invention set forth herein will come to mind to one skilled in the art having the benefit of the teaching presented in the foregoing description and associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A remotely operated wireless valve actuator assembly comprising:
a) an actuator unit comprising an actuator stem, wherein the actuator unit is configured to rotate the actuator stem;
b) a power unit;
c) a supply line connecting the power unit to the actuator unit, wherein the power unit is configured to send a control signal through the supply line to cause the actuator unit to rotate the actuator stem;
d) a first mounting plate configured to mount the actuator unit to a valve sub; and
e) a second mounting plate configured to mount the power unit to the valve sub.

2. The remotely operated wireless valve actuator assembly of claim 1, wherein the actuator unit is a rotary actuator unit.

3. The remotely operated wireless valve actuator assembly of claim 1, wherein the actuator unit is a linear actuator unit.

4. The remotely operated wireless valve actuator assembly of claim 3, wherein the linear actuator unit includes a hydraulic cylinder and a crank arm, wherein the crank arm is configured to convert linear motion of the hydraulic cylinder into rotational motion of the actuator stem.

5. The remotely operated wireless valve actuator assembly of claim 1, wherein the power unit is a hydraulic power unit, and wherein the control signal is hydraulic pressure.

6. The remotely operated wireless valve actuator assembly of claim 5, wherein the hydraulic power unit comprises a power source, a controller configured to receive and process a remote user input, and a pump configured to generate the hydraulic pressure and to deliver the hydraulic pressure to the actuator unit via the supply line.

7. The remotely operated wireless valve actuator assembly of claim 6, wherein the supply line comprises a hose.

8. The remotely operated wireless valve actuator assembly of claim 1, wherein in the power unit is a pneumatic power unit, and wherein the control signal is pneumatic pressure.

9. The remotely operated wireless valve actuator assembly of claim 8, wherein the pneumatic power unit comprises a power source, a controller configured to receive and process a remote user input, and a pump configured to generate the pneumatic pressure and to deliver the pneumatic pressure to the actuator unit via the supply line.

10. The remotely operated wireless valve actuator assembly of claim 9, wherein the supply line comprises a hose.

11. The remotely operated wireless valve actuator assembly of claim 1, wherein the power unit is an electric power unit, and wherein the control signal is electric signals.

12. The remotely operated wireless valve actuator assembly of claim 11, wherein the electric power unit comprises a control panel configured to deliver the electric signals and power to the actuator unit via the supply line.

13. The remotely operated wireless valve actuator assembly of claim 12, wherein the supply line comprises a cable.

14. The remotely operated wireless valve actuator assembly of claim 1, wherein the first mounting plate comprises a first surface for supporting the actuator unit and a second surface configured to engage the valve sub.

15. The remotely operated wireless valve actuator assembly of claim 1, wherein the second mounting plate comprises a first surface for supporting the power unit and a second surface configured to engage the valve sub.

16. A valve sub assembly comprising:
a) a valve sub comprising a sub housing, a ball valve disposed within the sub housing, a valve stem configured to rotate the ball valve between an open position and a closed position, and a stem aperture extending through the sub housing to reach the valve stem;
b) a remotely operated wireless valve actuator assembly, comprising:
i) an actuator unit mounted on the valve sub, the actuator unit comprising an actuator stem extending through the stem aperture and engaging the valve stem;
ii) a power unit mounted on the valve sub; and
iii) a supply line connecting the power unit to the actuator unit, wherein the power unit is configured to operate the actuator unit to rotate the actuator stem, wherein rotation of the actuator stem causes rotation of the valve stem, wherein rotation of the valve stem causes the ball valve to move between an open position and a closed position within the valve sub.

17. The valve sub assembly of claim 16, wherein the supply line is configured to remain connected between the actuator unit and the power unit when the valve sub rotates during drilling operations.

18. A method of actuating a remotely operated wireless valve actuator assembly, the method comprising:
a) mounting a power unit to a valve sub, the valve sub comprising a sub housing, a ball valve disposed within the sub housing, a valve stem configured to rotate the ball valve between an open position and a closed position, and a stem aperture extending through the sub housing to reach the valve stem;
b) mounting an actuator unit to the valve sub, the actuator unit comprising an actuator stem, wherein upon mounting the actuator stem extends through the stem aperture and engages the valve stem;
c) connecting the actuator unit to the power unit via a supply line;
d) receiving a remote user input at the power unit;
e) sending a control signal from the power unit to the actuator unit via the supply line to cause the actuator unit to rotate the actuator stem, thereby rotating the valve stem to move the ball valve between the open position and the closed position.

19. The method of claim 18, wherein sending the control signal comprises supplying fluid or gas through the supply line.

20. The method of claim 18, wherein sending the control signal comprises supplying electrical power through the supply line.
